(19) United States
(12) Patent Application Publication
(10) Pub. No.: US 2004/0226350 A1
(43) Pub. Date: Nov. 18, 2004

(54) Apparatus and method for testing endurance of optical disc

(76) Inventors: Jin Hong Kim, Yongin-si (KR); Hun Seo, Yongin-si (KR); Chang Ho Lee, Goyang-si (KR); Tae Hee Jeong, Seongnam-si (KR); Keum Cheol Kwak, Seoul (KR); Seoung Won Lee, Daedeok-gu (KR)

Correspondence Address: HARNESS, DICKEY & PIERCE, P.L.C., P.O. BOX 8910, RESTON, VA, 20195, US

(21) Appl. No.: 10/801,041

(22) Filed: Mar. 16, 2004

(30) Foreign Application Priority Data
Mar. 17, 2003 (KR) 10-2003-16514

(51) Int. Cl. G01N 3/46

(52) U.S. Cl. 73/81

(57) ABSTRACT

An apparatus and method for testing an endurance of an optical disc, whereby the reliability of the test is enhanced, is disclosed. The method includes fixing the optical disc on a rotation plate, and rotating the optical disc along with the rotation plate, supplying a predetermined pressure to the scratcher, while the optical disc rotates for a predetermined number of rotation turns, so as to produce a scratch on a surface of the optical disc, resulting from a contact with the scratcher, and determining the endurance of the optical disc based on the scratch produced on the surface of the optical disc.

### CROSS-REFERENCE TO RELATED APPLICATIONS

This application claims the benefit of Korean Application No. P2003-016514, filed on Mar. 17, 2003, which is hereby incorporated by reference as if fully set forth herein.

### BACKGROUND OF THE INVENTION

1. Field of the Invention

The present invention relates to an apparatus and method for testing an optical disc, and more particularly, to an apparatus and method for testing an endurance of a surface of an optical disc. Although the present invention is suitable for a wide scope of applications, it is particularly suitable for providing a standardized criterion for testing the endurance of the optical disc, thereby enhancing the reliability of the endurance test.

2. Discussion of the Related Art

In recent technology, the recording media includes magnetic tapes, optical discs, such as laser discs and compact discs, and digital video discs (DVD's) capable of storing large capacity information. Recently, standardization of Blu-ray Disc (BD), which is a new high-density optical disc capable of recording large capacity high-quality video and audio data, is in progress. Among such recording media, unlike the conventional magnetic tape, the optical disc stores data in a digital recording method and is extremely small in volume and lightweight, thereby facilitating storage and portability.

However, the optical disc has the disadvantages of scratches formed on the surface of the disc, deformity, and foreign materials formed during the manufacturing process, which strikingly deteriorates the functions of the optical disc. Thus, a wide range of tests is required to resolve and overcome such problems. For example, the functions and the endurance of the optical disc are tested by measuring a high frequency signal, a jitter, a focusing error signal, a tracking error signal, and so on, based on signals represented from the optical disc.

The endurance test is carried out to test the endurance of a protective layer formed to prevent physical damage on the surface of the optical disc. In recent technology, the most widely used types of endurance tests are a pencil hardness test, and a taber abrasion test.

In the pencil hardness test, a plurality of pencils each having a different hardness are contacted on the surface of the optical disc, so as to scratch the surface of the disc. Herein, the endurance of the optical disc is tested based upon the hardness of the pencil that produces scratches on the surface of the optical disc. On the other hand, in the taber abrasion test, an abrasion wheel is used to wear away the surface of the optical disc, and the endurance of the optical disc is tested based upon the abrasive wear thereof.

However, in the pencil hardness test, the tester manually contacts each pencil on the surface of the optical disc, and, therefore, the tester is unable to apply a uniform pressure on the pencils. Eventually, the shape and the location of the scratches cannot be uniform. Also, in the taber abrasion test, while using the abrasion wheel, the abrasive wear on the surface of the optical disc is very different from the scratches on the optical disc. Therefore, testing the endurance of the optical disc based on the abrasive wear caused by the abrasion wheel is not appropriate. Moreover, since the criterion of whether the optical disc is normal or deficient is not standardized in both of the testing methods, the test results for the endurance of the optical disc cannot be highly reliable.

### SUMMARY OF THE INVENTION

Accordingly, the present invention is directed to an apparatus and method for testing an endurance of an optical disc that substantially obviates one or more problems due to limitations and disadvantages of the related art.

An object of the present invention is to provide an apparatus and method for testing an endurance of an optical disc having an enhanced reliability of the endurance test.

Another object of the present invention is to provide an apparatus and method for testing an endurance of an optical disc having a standardized criterion for the endurance test.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for testing an endurance of an optical disc includes a rotation plate rotating the optical disc, a scratching unit producing a scratch on a surface of the optical disc, and a frame supplying a predetermined pressure on the scratching unit and causing the scratching unit to contact the optical disc, so as to produce a scratch on the surface of the optical disc.

The scratching unit includes a scratcher producing a scratch on the surface of the optical disc, and a holder fixing the scratcher, and the scratcher is formed of steel wool.

The frame supplies a predetermined pressure in the range of 50 to 5000 gf/cm² to the scratching unit. The frame supplies either a pressure caused by its own weight to the scratching unit or a pressure caused by vapor.

In another aspect of the present invention, a method for testing an endurance of an optical disc includes fixing the optical disc on a rotation plate, and rotating the optical disc along with the rotation plate, supplying a predetermined pressure to the scratcher, while the optical disc rotates for a predetermined number of rotation turns, so as to produce a scratch on a surface of the optical disc, resulting from a contact with the scratcher, and determining the endurance of the optical disc based on the scratch produced on the surface of the optical disc.

Herein, the supplying a predetermined pressure to the scratcher includes having the optical disc rotate for 5 rotation turns or less.

The pressure applied to the scratcher is decided differently depending upon a predetermined number of rotation turns of the optical disc. And, the pressure applied to the scratcher is decided to be at a low level when the predetermined number of rotation turns of the optical disc is high, and at a high level when the predetermined number of rotation turns of the optical disc is low. Herein, the pressure applied to the scratcher is decided within the range of 500 to 1500 gf/cm².

The determining the endurance of the optical disc includes determining the optical disc to be deficient when the depth of the scratch is equal to or more than 2 micrometers (μm), and determining the optical disc to be normal when the depth of the scratch is less than 2 micrometers (μm).

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings;

FIG. 1 illustrates an apparatus for testing an endurance of a surface of an optical disc according to the present invention;

FIG. 2 illustrates a flow chart of a method for testing the endurance of the surface of the optical disc according to the present invention;

FIG. 3 illustrates a scratch pattern formed on the optical disc by using a micro-scratch tester;

FIG. 4 illustrates an occurrence of a servo error in accordance with a scratch depth of a bare disc and a hard-coated disc;

FIG. 5 illustrates a graph showing the test results of the scratch depths based upon the pressure applied to the optical disc; and

FIG. 6 illustrates a graph showing the jitter values based upon the number of rotation turns of the optical disc.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

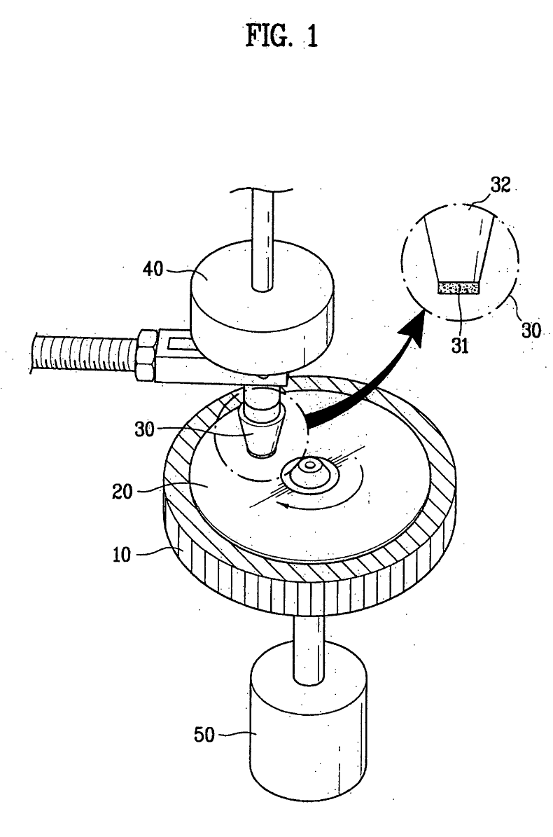

FIG. 1 illustrates an apparatus for testing an endurance of a surface of an optical disc according to the present invention. Referring to FIG. 1, the apparatus for testing the endurance of the optical disc according to the present invention includes a rotation plate 10, a scratching unit 30, and a frame 40.

The rotation plate 10 receives a rotation force from a motor 50 formed below the rotation plate 10 so as to rotate an optical disc 20 at a constant speed. The scratching unit 30 is fixed to the frame 40 and produces scratches on the surface of the optical disc 20. The frame 40 presses the scratching unit 30 with a constant pressure, so as to generate friction between the rotating optical disc 20 and the scratching unit 30. The frame 40 supplies the scratching unit 30 with either a constant pressure generated from its own load or a constant vapor pressure.

The scratching unit 30 includes a scratcher 31 producing scratches on the surface of the optical disc, and a holder 32 fixing the scratcher 31. Herein, the scratcher 31 is formed of steel wool, and the types of steel wool include #0, #00, #000, and #0000.

The method for testing the endurance of the surface of the optical disc according to the present invention will now be described as follows.

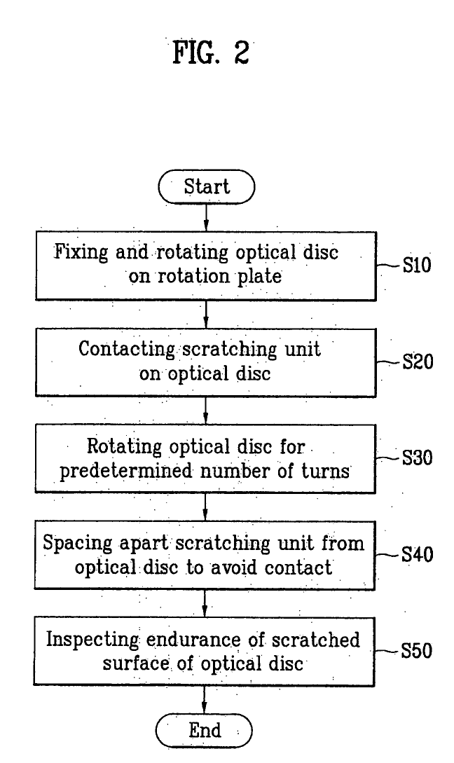

FIG. 2 illustrates a flow chart of a method for testing the endurance of the surface of the optical disc according to the present invention. Referring to FIG. 2, the optical disc 20 is fixed on the rotation plate 10, and then the motor 50 is operated so as to rotate the optical disc 20 along with the rotation plate 10 (S10). After placing the scratching unit 30 over the rotating optical disc 20, the scratching unit 30 is moved downwards to allow the scratcher 31 to come in contact with the surface of the optical disc 20 (S20). Subsequently, the frame 40 supplies the scratching unit 30 with a constant pressure, thereby allowing the scratching unit 30 to contact the surface of the rotating optical disc 20 with a constant friction.

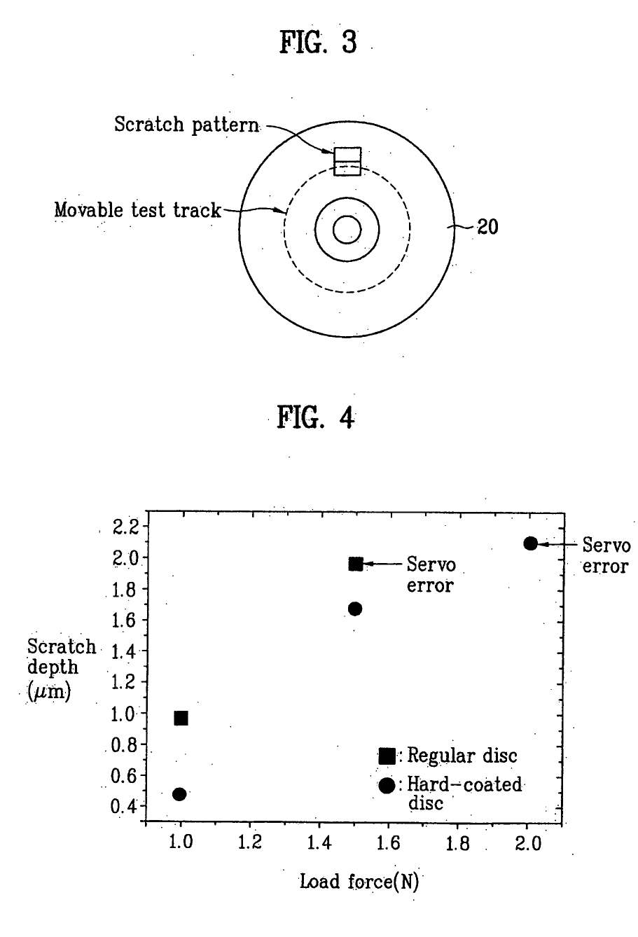

FIG. 3 illustrates a scratch pattern formed on the surface of the optical disc 20 by using a micro-scratch tester. The scratch pattern is used to determine and decide the optimum condition for the endurance test. Accordingly, depending upon the scratch pattern, the depth of the scratch, the pressure of the frame, which is the pressure applied to the optical disc 20, the type of scratcher 31, and the number of rotation turns of the optical disc 20 are selected for the test.

FIG. 4 illustrates an occurrence of a servo error in accordance with a scratch depth based on the pressure applied to the optical disc 20, more specifically, showing the comparison between a bare disc having no protective layer and a hard-coated disc. When the depth of the scratch is at least 2 micrometers (μm), a servo error occurs in both discs. Accordingly, when testing the endurance of the optical disc, it will be appropriate to set the standard scratch depth as 2 micrometers (μm) for determining whether the optical disc 20 is deficient or normal.

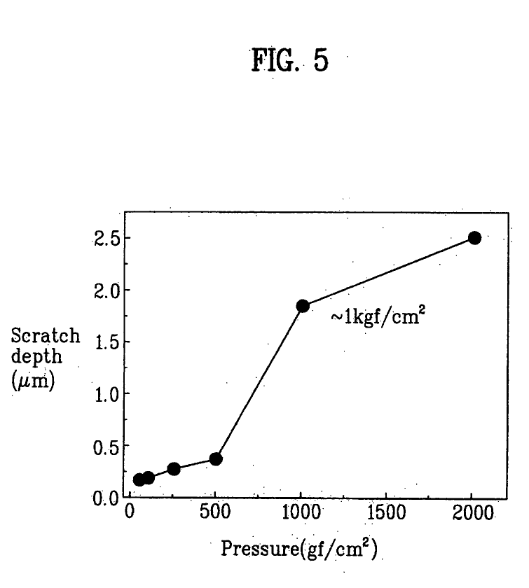

FIG. 5 illustrates a graph showing the scratch depths caused by a vertical pressure applied from the frame 40 to the optical disc 20. The graph shows the scratch depth formed under the condition, whereby a #000 steel wool is used as the scratcher 31 and the optical disc 20 is rotated for only one turn. Referring to FIG. 5, in order to produce a scratch having a depth of approximately 2 micrometers (μm), while the optical disc 20 rotates for one turn, the pressure of the frame 40 applied to the optical disc 20 should be 1000 gf/cm². Moreover, in order to produce a scratch having the depth of approximately 2 micrometers (μm), while the optical disc 20 rotates for two turns, the pressure of the frame 40 applied to the optical disc 20 should be equal to or less than 1000 gf/cm². Similarly, the pressure of the frame 40 can be determined based on the type of scratcher 31 and the number of rotation turns of the optical disc 20. The pressure of the frame 40 can be in the range of 50 to 5000 gf/cm², however, it is preferable that the pressure is set at the range of 500 to 1500 gf/cm².

Also, the number of rotations of the optical disc 20, while the scratcher 31 contacts the surface of the optical disc 20, is limited to a maximum of 5 rotation turns. The scratches that may occur during an actual usage of a user are caused by a plurality of casual scratches. Conversely, the scratch caused by the scratching unit 30 results from a plurality of rotation turns of the optical disc 20. And so, the two types of scratched described above cannot be the same. Therefore, in order to produce scratches that are most similar to the scratches that may occur during everyday usage, the number of rotation turns of the optical disc 20 should be limited to 5 turns or less.

As described above, when the pressure of the frame 40, the type of scratcher 31, and the number of rotation turns of the optical disc 20 are determined and set, the optical disc 20 rotates in accordance with the determined conditions, in order to scratch the surface of the optical disc 20 (S30). Subsequently, the scratching unit 30 is spaced apart from the optical disc 20 (S40), and the scratch is inspected so as to determine the endurance of the optical disc 20 (S50). When the depth of the scratch is equal to or more than 2 micrometers (μm), the optical disc 20 is determined to be deficient. Conversely, when the depth of the scratch is less than 2 micrometers (μm), the optical disc is determined to be normal.

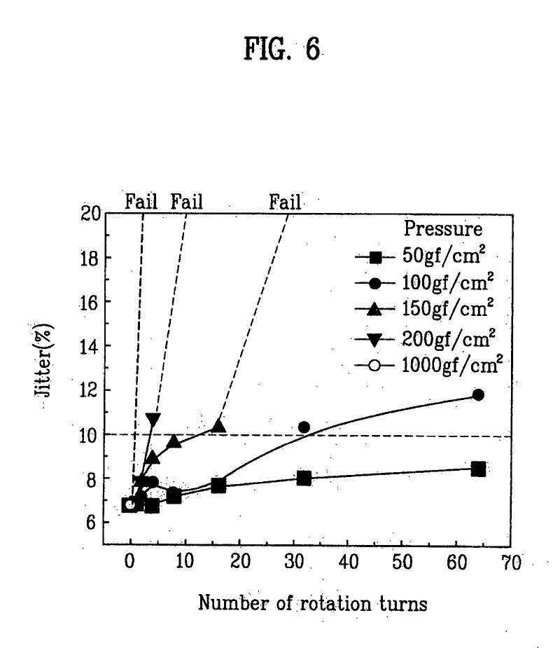

FIG. 6 illustrates a graph showing the jitter values based upon the pressure applied to the optical disc 20 and the number of rotation turns of the optical disc 20. Referring to FIG. 6, the jitter value increases in proportion to the pressure of the frame 40 applied to the optical disc 20 and the number of rotation turns of the optical disc 20.

Apart from the endurance test of the optical disc 20, a symbol error rate (SER) or a bit error rate (BER), a focusing error signal, which is a servo error signal, and a tracking error signal are measured, so as to optionally test the functions of the optical disc.

As described above, in the apparatus and method for testing the endurance of the optical disc according to the present invention, a tester scratch for testing the endurance of the optical scratch can be formed to be very similar the scratches that occur during everyday usage. Furthermore, a plurality of conditions required for testing the endurance of the optical disc can be standardized, thereby providing a test with a more enhanced and higher reliability.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An apparatus for testing an endurance of an optical disc, comprising:
a rotation plate rotating the optical disc;
a scratching unit producing a scratch on a surface of the optical disc; and
a frame supplying a predetermined pressure on the scratching unit and causing the scratching unit to contact the optical disc, so as to produce a scratch on the surface of the optical disc.

2. The apparatus according to claim 1, wherein the scratching unit includes a scratcher producing a scratch on the surface of the optical disc, and a holder fixing the scratcher.

3. The apparatus according to claim 2, wherein the scratcher is formed of steel wool.

4. The apparatus according to claim 1, wherein the frame supplies a predetermined pressure in the range of 50 to 5000 gf/cm² to the scratching unit.

5. The apparatus according to claim 1, wherein the frame supplies a pressure caused by its own weight to the scratching unit.

6. The apparatus according to claim 1, wherein the frame supplies a pressure caused by vapor.

7. The apparatus according to claim 1, further comprising a motor formed below the rotation plate and providing a rotation force to the rotation plate.

8. A method for testing an endurance of an optical disc, comprising:
fixing the optical disc on a rotation plate, and rotating the optical disc along with the rotation plate;
supplying a predetermined pressure to a scratcher, while the optical disc rotates for a predetermined number of rotation turns, so as to produce a scratch on a surface of the optical disc, resulting from a contact with the scratcher; and
determining the endurance of the optical disc based on the scratch produced on the surface of the optical disc.

9. The method according to claim 8, wherein the supplying a predetermined pressure to the scratcher includes having the optical disc rotate for 5 rotation turns or less.

10. The method according to claim 8, wherein the pressure applied to the scratcher is decided differently depending upon a predetermined number of rotation turns of the optical disc.

11. The method according to claim 10, wherein the pressure applied to the scratcher is decided to be at a low level when the predetermined number of rotation turns of the optical disc is high, and at a high level when the predetermined number of rotation turns of the optical disc is low.

12. The method according to claim 8, wherein the pressure applied to the scratcher is decided within the range of 500 to 1500 gf/cm².

13. The method according to claim 8, wherein the scratcher is formed of steel wool.

14. The method according to claim 8, wherein the determining the endurance of the optical disc includes determining the optical disc to be deficient when the depth of the scratch is equal to or more than 2 micrometers (μm), and determining the optical disc to be normal when the depth of the scratch is less than 2 micrometers (μm).
